(19) United States
(12) Patent Application Publication
(10) Pub. No.: US 2002/0052756 A1
(43) Pub. Date: May 2, 2002

(54) Method and apparatus for facilitating donations

(76) Inventor: Donna M. Lomangino, Arlington, VA (US)

Correspondence Address: Jack D. TODD, MORRIS, MANNING & MARTIN, LLP., 6000 Fairview Road, Suite 1125, Charlotte, NC, 28210, US

(21) Appl. No.: 10/003,332

(22) Filed: Oct. 31, 2001

Related U.S. Application Data
(60) Provisional application No. 60/244,190, filed on Oct. 31, 2000.

(51) Int. Cl. G06F 17/60

(52) U.S. Cl. 705/1; 705/35

(57) ABSTRACT

In a system in which donor members transfer items to recipient members without receiving economic remuneration from the recipient members, a preferred Internet method for facilitating a transfer of an item from a donor member to a recipient member includes: receiving information from each recipient member sufficient to classify each recipient member within predefined classes; receiving from a donor member information for a particular item to be donated, including a designation of at least one predefined class as an eligible class of recipient members for receiving the particular item; and identifying through a website the particular item to such eligible recipient members. A preferred method further includes receiving from a second donor member a pledge applicable to the transfer of the particular item and identifying the pledge to such eligible recipient members.

### CROSS REFERENCE TO RELATED APPLICATION

This application claims the benefit under 35 U.S.C. § 119(e) of U.S. provisional patent application No. 60/244,190, entitled, “Method and Apparatus for Recirculating Goods,” filed Oct. 31, 2000, which is incorporated herein by reference.

### FIELD OF THE PRESENT INVENTION

The present invention relates generally to a computerized system for forming a computer based communications network of donor and recipient members for facilitating donations of goods from donor members and retrieval of goods by recipient members through the computer based communications network of donor and recipient members.

### BACKGROUND OF THE PRESENT INVENTION

The related art is represented by the following patents of interest.

U.S. Pat. No. 5,446,919, issued on Nov. 14, 1995 to Henry Hovakimian, describes a credit/charge card which identifies a charity or charities to receive a donation, and a purchase processing system which processes the card user's transaction, pays a previously decided amount to the charity or charities, and also bills the cardholder. Hovakimian does not suggest a method and apparatus for recirculating goods according to the claimed invention.

U.S. Pat. No. 5,546,303, issued on Aug. 13, 1996 to Edward Helbling, describes a method of and system for correlating charitable contributions made at vending stations in food service establishments which issue information carriers in return for charitable contributions which are receipts for the contribution and entitle the donor to a beverage dispensed from a machine responding to the information carrier. Helbling '303 does not suggest a method and apparatus for recirculating goods according to the claimed invention.

U.S. Pat. No. 5,555,497, issued on Sep. 10, 1996 to Edward Helbling, describes a charitable contribution centralization system and apparatus that provides a multiplicity of charitable collection stations with selectors for choosing the charity to which a contribution is destined, a change marker for issuing change if desired, a display for displaying information with respect to premiums available and contributions made, and a modem or other telecommunicator for two-way communications with a central station. Helbling '497 does not suggest a method and apparatus for recirculating goods according to the claimed invention.

U.S. Pat. No. 5,663,547, issued on Sep. 2, 1997 to Witold A. Ziarno, describes a method of and device for streamlining, simplifying, and inducing the giving of contribution or gift commitments by contributors or prospective gift givers that involves dispersing through a crowd of prospective contributors or gift givers a plurality of keyless, electronic contributions or gifts management devices for immediate entry of a consecutive data comprising the identities of the contributors or gift givers making the monetary contribution commitments or monetary gift commitments. Ziarno '547 does not suggest a method and apparatus for recirculating goods according to the claimed invention.

U.S. Pat. No. 5,665,952, issued on Sep. 9, 1997 to Witold A. Ziarno, describes a method of streamlining the acknowledgement of a plurality of contribution or gift commitments including the steps of dispersing through a crowd of prospective contributors or gift givers located at a plurality of remote locations a plurality of portable, self-powered devices for the entry of data consisting essentially of monetary contribution or gift commitments, automatically correlating the data with address data of respective contributors or gift givers making monetary contribution or gift commitments from a remote data processing location from where the contribution or gift commitments were entered. Ziarno '952 does not suggest a method and apparatus for recirculating goods according to the claimed invention.

U.S. Pat. No. 5,793,861, issued on Aug. 11, 1998 to Stephen P. Haigh, describes a transaction processing system and method that includes a transaction interface for conveying transactions, a memory for storing the transactions in a queue, and a processor. Haigh does not suggest a method and apparatus for recirculating goods according to the claimed invention.

U.S. Pat. No. 5,794,219, issued on Aug. 11, 1998 to Stephen J. Brown, describes a method of conducting an on-line auction that permits individual bidders to pool bids during a bidding session. Brown does not suggest a method and apparatus for recirculating goods according to the claimed invention.

U.S. Pat. No. 5,887,273, issued on Mar. 23, 1999 to Witold A. Ziarno, describes an offering plate that permits an attendee at a religious service to make a donation that consists of a cash donation acceptor, an envelope donation acceptor, a credit card donation processor, and/or a debit card donation processor. Ziarno '273 does not suggest a method and apparatus for recirculating goods according to the claimed invention.

U.S. Pat. No. 6,029,195, issued on Feb. 22, 2000 to Frederick S. M. Herz, describes a system for customized electronic identification of desirable objects in an electronic media environment, wherein the system enables a user to access target objects of relevance and interest to the user without requiring the user to expend an excessive amount of time and energy. Herz does not suggest a method and apparatus for recirculating goods according to the claimed invention.

Germany Patent document 197 20 964 A1, published on Nov. 19, 1998, describes a charity contribution system that uses a telephone connection between a telephone handset used by the contributor and a central processor, with the cost of the telephone call connection being automatically booked to the contributor. Germany '964 does not suggest a method and apparatus for recirculating goods according to the claimed invention.

International Patent document WO 97/46985, published on Dec. 11, 1997, describes a donation redemption system for making it feasible to donate refunded monetary values to charity, the monetary values being paid as compensation for used commodity objects returned to a reverse vending machine for the purpose of reuse thereof, or for recycling of materials recoverable therefrom. Hovakimian does not suggest a method and apparatus for recirculating goods according to the claimed invention.

An Internet web site entitled CommunityBids.com describes a service that allows groups to organize and hold an on-line auction fundraiser. This web site does not suggest a method and apparatus for recirculating goods according to the claimed invention.

None of the above inventions and patents, taken either singly or in combination, is seen to describe the present invention.

### SUMMARY OF THE PRESENT INVENTION

Briefly described, the present invention relates to a system in which donor members transfer items to recipient members without receiving economic remuneration from the recipient members. In this system, a method for facilitating a transfer of an item from a donor member to a recipient member includes the steps of: (a) receiving information from each recipient member sufficient to classify each recipient member within predefined classes; (b) receiving from a donor member information for a particular item to be donated, including a designation of at least one of the predefined classes as an eligible class of recipient members for receiving the particular item; and (b) identifying the particular item to recipient members of the at least one eligible class. The particular item is thereby made available for retrieval by one of the eligible recipient members from the donor member.

In features of the method, the predefined classes of recipient members may or may not be mutually exclusive; a predefined class of recipient members may include charitable organizations, businesses, individuals, or schools; the items to be transferred may be categorized for ease of identification to the recipient members; and the items may include clothes, equipment, electronics, toys, cars, linens, appliances, crutches, eyeglasses, household items, construction materials, furniture, cell phones, fax machines, surplus goods, redistribution items, reallocation items, refurbished items, or recyclable items.

In the preferred system each of the donor members and recipient members must registered with a facilitator in order to participate in the system-the facilitator performing the method of the present invention. The information also is received from each member during registration with the facilitator. The facilitator includes a website on the Internet, and the method is performed, at least in part, by way of the Internet.

In a preferred method, the particular item is identified to all users of the system but can only be retrieved by a member of the designated class. In an alternative method, the particular item is not identified to recipient members of the undesignated classes. In another alternative method, the particular item is identified to recipient members of the undesignated classes, but only after a predetermined period of time in which the particular item remains available for retrieval by a recipient member of the at least one eligible class.

Another preferred method includes soliciting for a donation applicable to the transfer of the particular item to a recipient member. The solicited donation may include money to cover at least one of shipping cost, cleaning cost, and packaging cost. Yet another preferred method includes the steps of receiving from a second donor member a pledge applicable to the transfer of the particular item and identifying such pledge to recipient members of the at least one eligible class.

The present invention also includes a computer-readable medium having computer-executable instructions for facilitating a transfer of an item from a donor member to a recipient member in a system in which donor members transfer items to recipient members without receiving economic remuneration from the recipient members. The computer-executable instructions perform the steps of: receiving information from each recipient member sufficient to classify each recipient member within predefined classes; receiving from a donor member information for a particular item to be donated, including a designation of at least one of the predefined classes as an eligible class of recipient members for receiving the particular item; and identifying the particular item to recipient members of the at least one eligible class.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a block diagram of a computerized system in which a preferred system of the present invention is implemented.

FIG. 2 shows a portion of a web site layout for use with a computerized recirculation system process according to the present invention.

FIG. 3 shows an additional portion of a web site layout for use with a computerized recirculation system process according to the present invention.

FIG. 4 shows an additional portion of a web site layout for use with a computerized recirculation system process according to the present invention.

FIG. 5 shows an additional portion of a web site layout for use with a computerized recirculation system process according to the present invention.

FIG. 6 shows an additional portion of a web site layout for use with a computerized recirculation system process according to the present invention.

FIG. 7 shows an additional portion of a web site layout for use with a computerized recirculation system process according to the present invention.

FIG. 8 shows an additional portion of a web site layout for use with a computerized recirculation system process according to the present invention.

FIG. 9 shows an additional portion of a web site layout for use with a computerized recirculation system process according to the present invention.

FIG. 10 shows an additional portion of a web site layout for use with a computerized recirculation system process according to the present invention.

FIG. 11 shows an additional portion of a web site layout for use with a computerized recirculation system process according to the present invention.

FIG. 12 shows an additional portion of a web site layout for use with a computerized recirculation system process according to the present invention.

FIG. 13 shows an additional portion of a web site layout for use with a computerized recirculation system process according to the present invention.

FIG. 14 shows an additional portion of a web site layout for use with a computerized recirculation system process according to the present invention.

FIG. 15 depicts an embodiment of a home site web interface according to the present invention.

FIG. 16 depicts an embodiment displaying an item to be donated to a recipient member via a web interface according to the present invention.

FIG. 17 depicts an embodiment displaying an item sought to be donated from a donor member via a web interface according to the present invention.

FIG. 18 depicts an embodiment displaying a user account via a web interface according to the present invention.

### DETAILED DESCRIPTION OF PREFERRED EMBODIMENTS

In general, the recirculation system is designed for use by users of the system. A user is a donor member, a recipient member, or both. Depending upon who or what they are, recipient members are classified into one of a plurality of predefined classes, discussed in greater detail hereinafter. The recirculation system is programmed to gather a predetermined sequence of information from the user on the items the user wishes to donate/receive and to transmit the information to the central processor of the recirculation web server. In response to the gathered information, the central processor of the recirculation web server extracts the desired information from its storage and transmits it back to the user.

Possibilities for exchange (donation and receipt) are endless. Preferably, the system is a dedicated web site, which acts as a centralized, global repository of all recirculable goods on the Internet, which maximizes the recirculation of such goods. In other embodiments, the system is merely a subsystem included in other web sites, which facilitates the recirculation of goods between users of the other web sites. The term “goods” is intended to mean any chattel property or other physical item and includes anything from clothing, toys, cars, linens, household items, appliances, equipment, crutches, eyeglasses, furniture, electronics, electronic equipment, computer equipment, cell phones, fax machines, construction materials, surplus goods or the like. Through the system, businesses are able to identify areas or location, which yield the most advantageous collection points for any given good or item.

Recipient members, such as charities, churches, and schools, are able to use the system to find exactly what they need for their particular communities. Charities no longer have to ask only for money because they can select only what they need from the recirculation web site.

When a donor member lists an item for donation, the donor member designates whether the item is intended for a particular class of recipient members, such as charities, businesses, or either. Preferably, if no charities or businesses claim the item within a predetermined amount of time, the item is made available to a recipient member of any class. Such “roll-over” of items helps to raise public awareness about recycling and, in addition, helps to prevent the item from ending up in a landfill.

Preferably, recipient members classified as charity are permitted to receive items (or a predetermined number, volume, or type of items in a given period) without paying fees or costs. In some situations, however, it may be necessary for such recipient members to pay for shipping or “pick-up” costs. For example, a donor member may specify that she is willing to donate an item but not pay for shipping, in which case, the charity recipient member may be obligated to pay for shipping. In some cases, the system includes a list of philanthropic donor members who have agreed to pay for or assist in paying for the shipping costs, cleaning, and/or packaging of some types of items or donations to specified recipient members, by name or by classification. For example, such a donor member may offer to pay for a houseful of furniture to be shipped to a new home built by a particular charity, such as Habitat for Humanity. In order for a recipient member to qualify for the charity classification, it must be a “charitable organization,” recognized and awarded such status by the IRS, or other tax processing governmental body. Charitable organizations include nonprofit, tax-exempt organizations that are classified under Section 501(c)(3) of the IRS Code. This classification is a reliable indicator of the tax deductibility of contributions and gifts. Charitable organizations defined under Section 501(c)(3) of the IRS Code are divided into two classes: public charities and private foundations. A public charity solicits funds from the public and uses the funds to sponsor or support social, educational, or religious activities, or engage in activities that provide for relief for distressed or underprivileged individuals. Public charities are defined in Section 509(a)(1-4) of the IRS Code.

Included in the group of charitable organizations are churches, conventions or associations of churches; educational organizations; hospitals and medical research organizations; organizations created to benefit state and municipal colleges and universities that normally receive their support from the government or the general public; and other publicly supported organizations such as museums, libraries, support groups for cultural organizations, organizations for the gathering of contributions and gifts for research into and the elimination of medical disorders, and organizations that provide direct services to the public.

Community programs and businesses, which employ the homeless or provide rehabilitative services, are permitted to act as donor members, which provide inexpensive or free resources for cleaning, boxing, and perhaps delivering merchandise within localized areas. In this manner, by bringing together a vast array of donor and recipient members, the system of the present invention brings communities together through the network it establishes and the interrelationships it weaves.

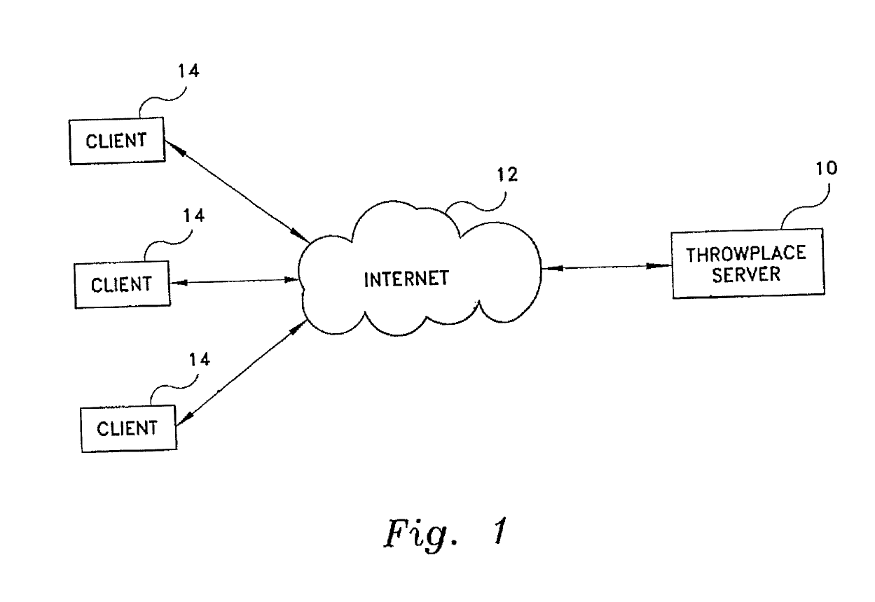

Referring now to the drawings, in which like numerals indicate like elements throughout the several views, FIG. 1 depicts the computerized recirculation system of the present invention, which includes client computers and/or web-enabled devices 14 connected via a network 12, such as the Internet, to a recirculation web server 10. If the network 12 is the Internet, potential donor and recipient members preferably use computers 14 to access the Internet using any standard web browser. The recirculation software on the web server 10 operates the system and the associated web pages and leads the user through a logical step-by-step process that helps the user donate and/or retrieve items. In order for a user to become a donor or recipient member, the user must complete a registration process by providing necessary data about herself. Additional information and confirmation of information may be necessary for a recipient member to qualify for a particular class, as will be discussed hereinafter. Once registered, the system user is permitted to donate and/or retrieve items using the system.

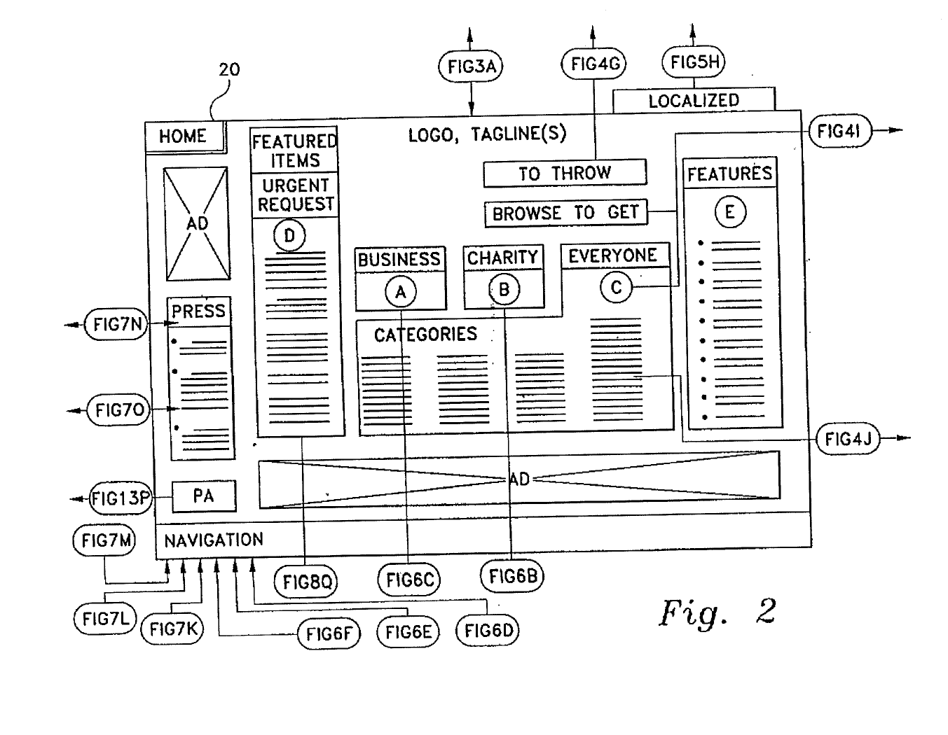

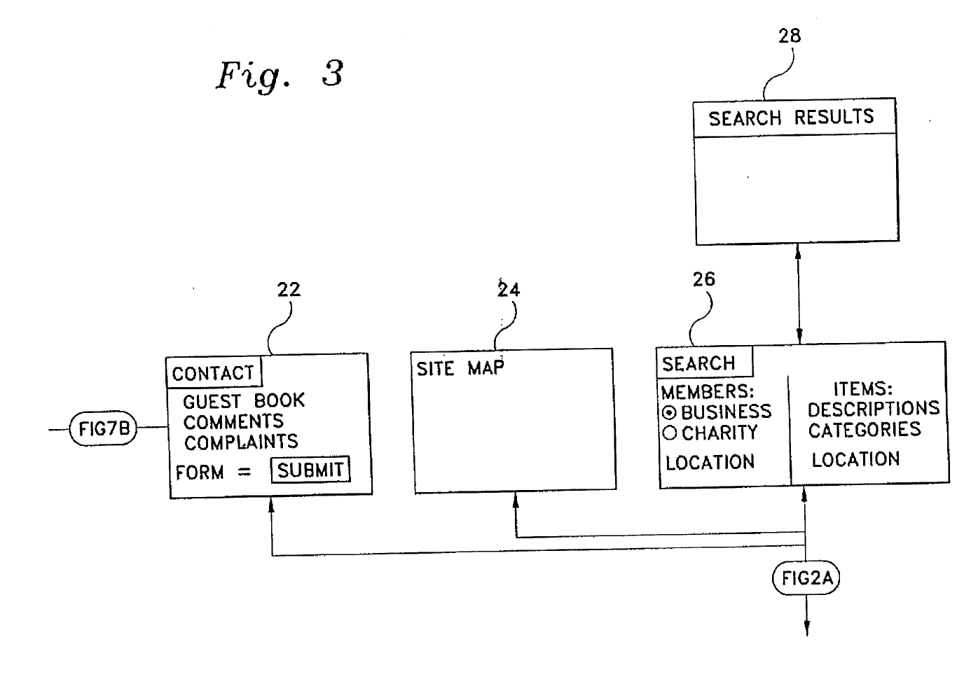

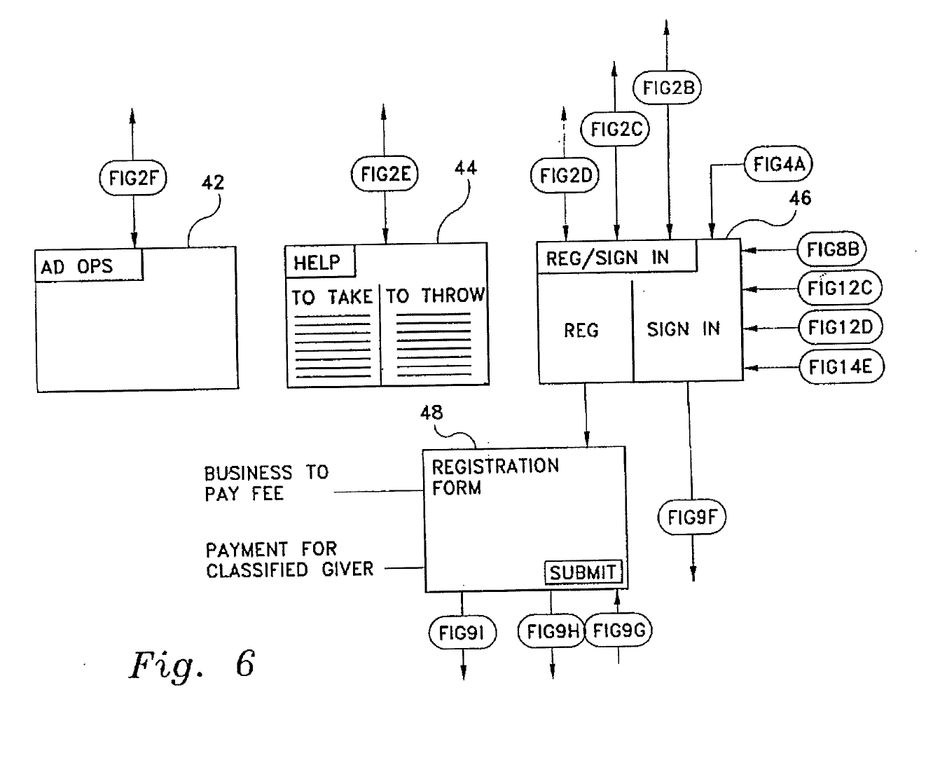

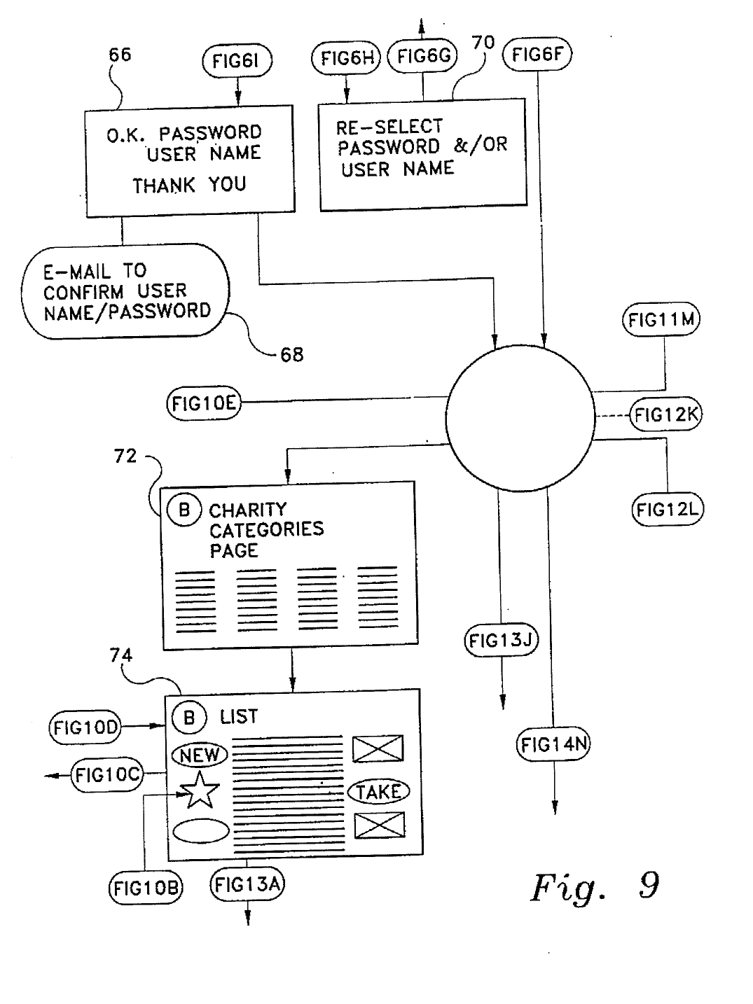

The invention can be understood readily from the following description of the preferred embodiment in conjunction with the flow diagrams shown in FIGS. 2-14 in which communication between donor and recipient members and the system is discussed. FIGS. 2-14 illustrate an exemplary web site architecture that may be used to provide access to the system over the Internet. Links and, hence, flow between the various exemplary web pages of this web site architecture are illustrated by means of letter (A, B, C, D, etc . . . ) pointers. These pointers include a figure number as well as the letter reference associated with that figure number. For example, as shown in FIG. 2 the flow from the “Logo Tagline(s)” at the center-top of FIG. 2 is indicated by icon “FIG. 3A”, which indicates a link A leading to FIG. 3, as opposed to a reference to FIG. 3a (which intentionally does not exist). Further, when turning to FIG. 3, the “return link” or pointer A back to FIG. 2 is indicated as Flow FIG. 2A. Thus, such icons (e.g., FIG. 6C, FIG. 9L) refer to locations on a particular figure as opposed to a figure number.

Turning now to FIG. 2, an exemplary World Wide Web Home Page 20 is illustrated in block diagram format. When accessing the system over the Internet, a visitor to the system is initially directed to Home Page 20. Home Page 20 includes a variety of links to other web pages as well as informational content, such as BUSINESS, CHARITY, EVERYONE, EVERYONE(CATEGORIES), BROWSE TO GET, FEATURED ITEMS, URGENT REQUESTS, and other FEATURES. Other less significant links include HOW TO THROW/GIVE, PRESS RELEASES, LOGO and TAGLINE(S), LOCALIZED-SEARCHES, and the general NAVIGATION links.

The BUSINESS section (circle A) of the Home Page 20 is basically a log-in or registration area for recipient members classified as businesses (or “for profit” companies). In contrast, the CHARITY section (circle B) of the Home Page 20 is basically a log-in or registration area for recipient members classified as charitable organizations (or “not-for-profit” companies or organizations). The registration or log-in process for businesses or charities is discussed in greater detail in association with FIG. 6 herein.

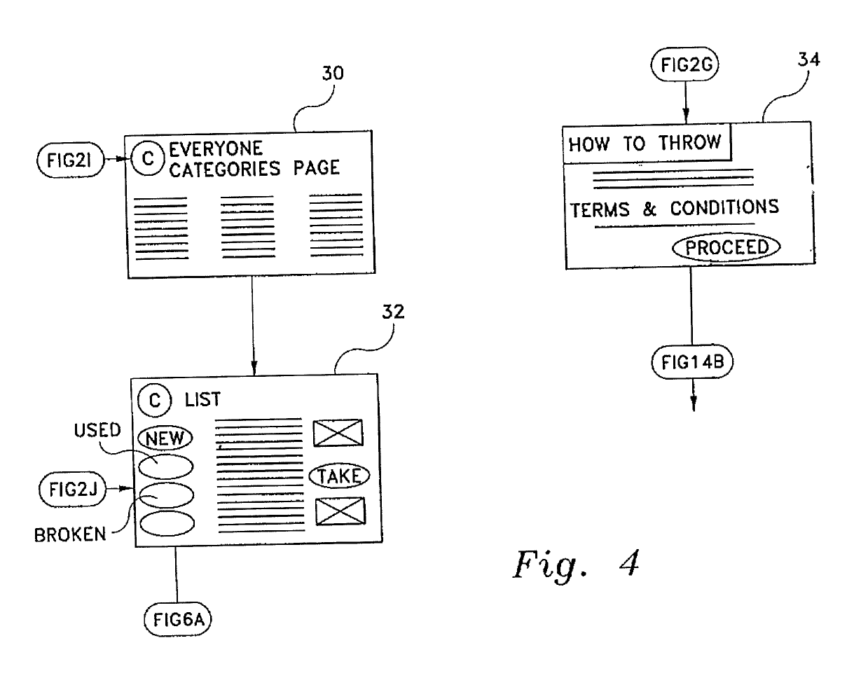

The EVERYONE (circle C), EVERYONE(CATEGORIES), and BROWSE TO GET sections of the Home Page 20 are open to the public and to any registered users of the web site. Activating any one of these links transfers the user to the web pages 30, 32, which identify items available on the system for any registered user of the system. Web page 30,32 are discussed in greater detail in association with FIG. 4.

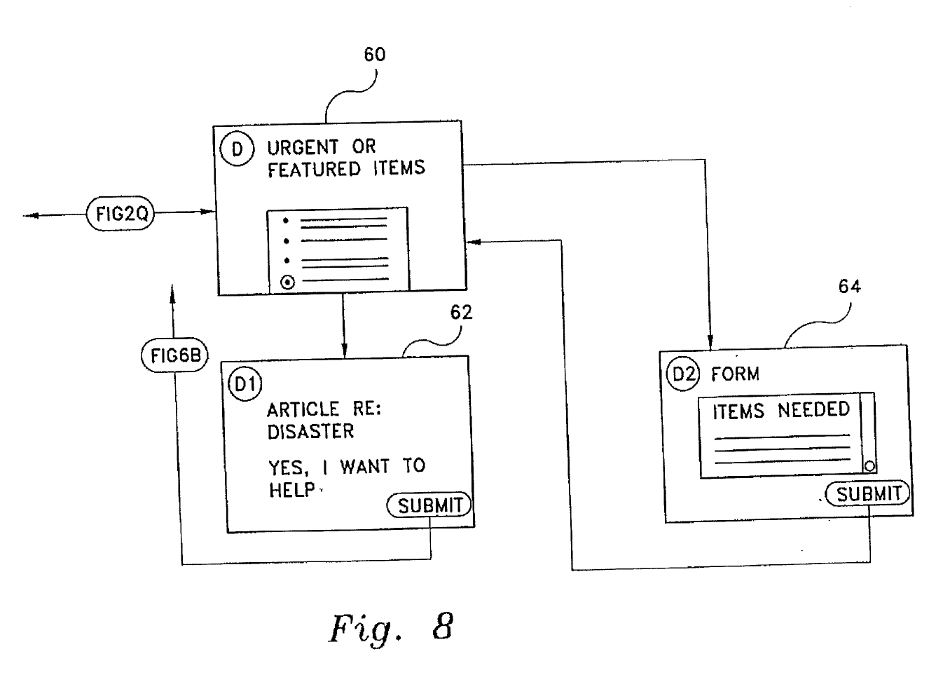

The FEATURED ITEMS section of the Home Page 20 identifies items that are available to “take.” Such items may be restricted for taking to a particular class of recipient members or may be open to all classes, including the public. The URGENT REQUEST section identifies items that are needed for donation. Such items may be needed to respond to special crises or events, such as natural disaster, or the like. Items selected for inclusion in these sections (circle D) of the Home Page 20 are generally selected by the operator of recirculation web server. These sections of the Home Page 20 link to web pages in FIG. 8, which are described in greater detail hereinafter.

The LOGO and TAGLINE section of the Home Page 20 provides an area in which the operator of the system may include trademarks or other marketing materials. This section of the Home Page 20 also preferably includes additional links to a contacts web page 22, a site map web page 24, and a web site search web page 26. These web pages are briefly discussed in association with FIG. 3 hereinafter.

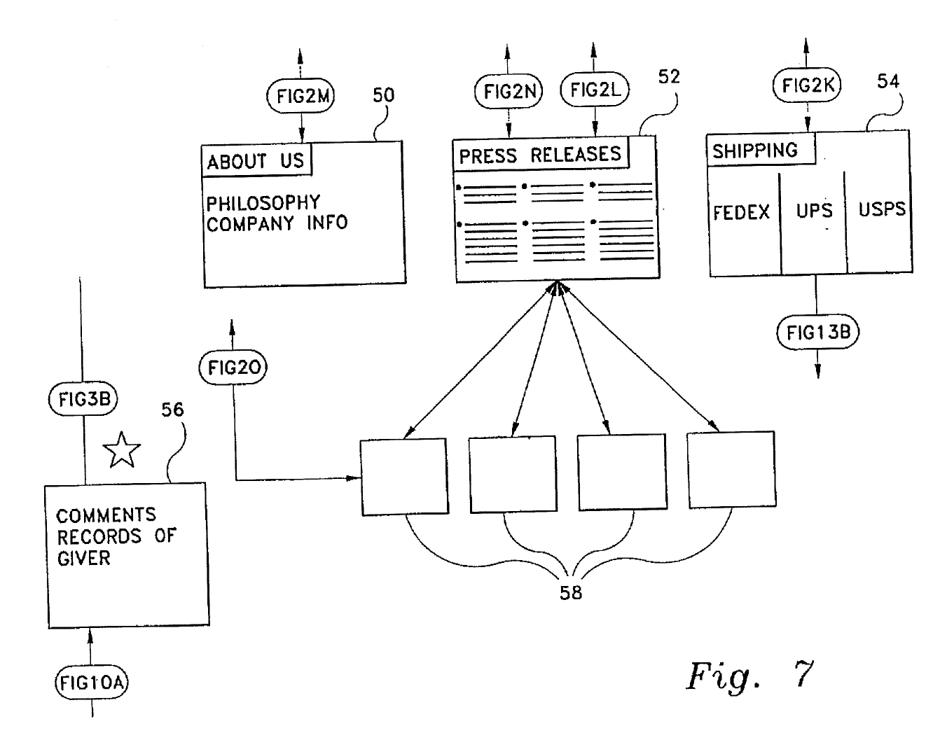

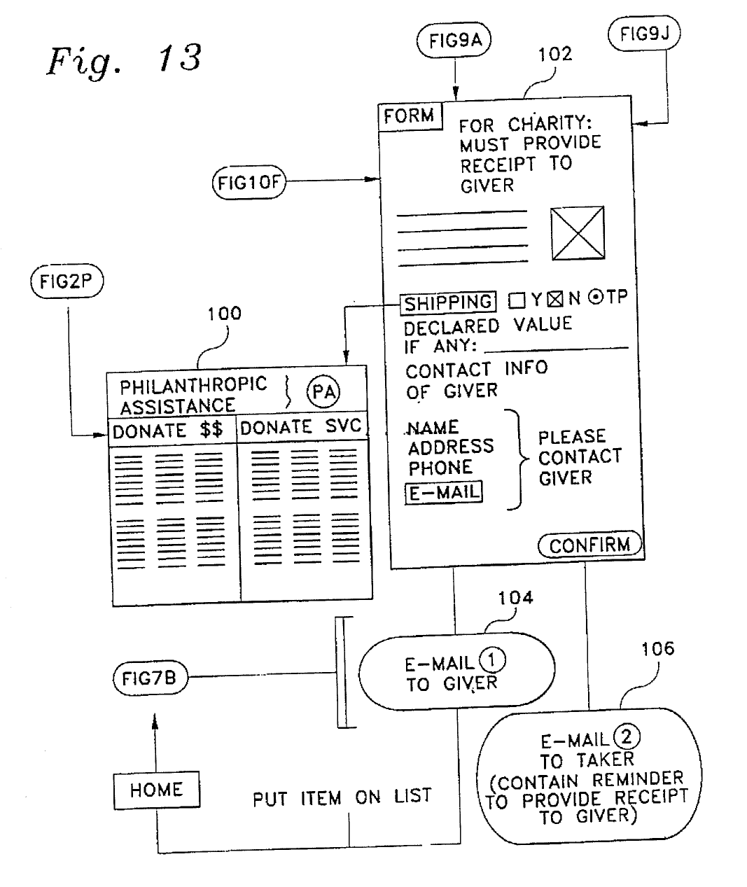

The “PA” section of the Home Page 20 provides a link to the Philanthropic Assistance (PA) web page 100, described in greater detail in association with FIG. 13. The Home Page 20 also includes a PRESS RELEASE section, in which links to press releases and news articles are provided. Web pages providing such press releases and news articles are described in association with FIG. 7.

The Home Page 20 further includes a TO THROW link, which links to an instructional web page 34 that explains to a user and to the public “how to throw” or donate an item using the web site. This web page 34 is described briefly in association with FIG. 4 hereinafter.

The NAVIGATION section at the bottom of the Home Page 20 generally includes duplicate links (duplicate to other links on the Home Page 20) to other web pages within the system.

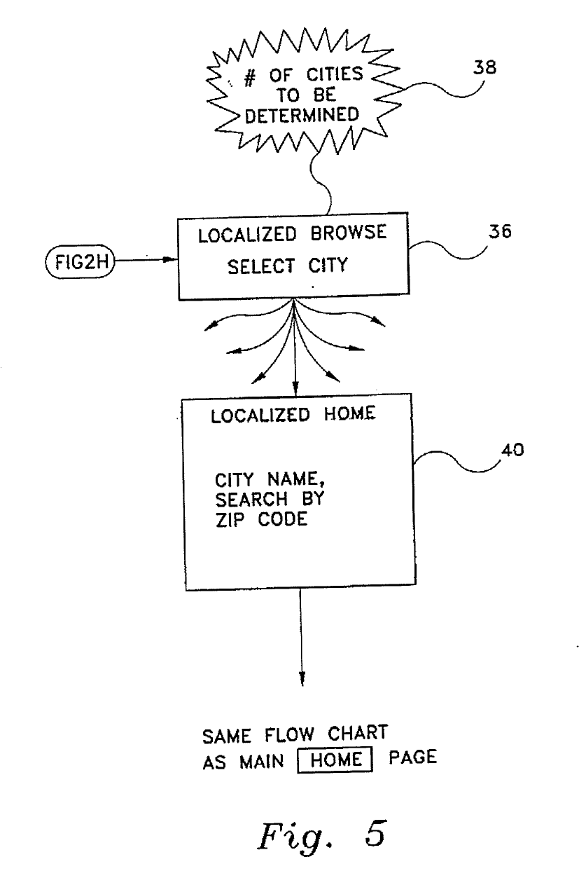

Finally, a user of the web site can view a “localized” version of the Home Page 20 by selecting the LOCALIZED icon at the top of the Home Page 20. Once selected, the user is taken to a series of web pages described in association with FIG. 5, by which the user is able to limit the view of items available for donation and taking to the specified localized area chosen by the user.

Referring now to FIG. 3, the search web page 26 enables any user of the system to search for an item based on characteristics of the item, including such aspects as Location (city, county, state, region of the country), Categories (type of item), Descriptions (of the item), and membership type (which class of users may receive the item), either separately or in combination. Search results are displayed on a separate search results web page 28, which is directly linked to the search web page 26. Even though the search results may show that an item is available, the user may not be able to get the item if she is not in the class of users to which the item is restricted. Alternatively, items may only be identified to those users of an eligible class whereby users not eligible to take are restricted from viewing items up for donation.

The site map web page 24 and contact web page 22, which enables a user to sign a guest book, provide comments, feedback or complaints through a form, are conventional and not described in detail herein.

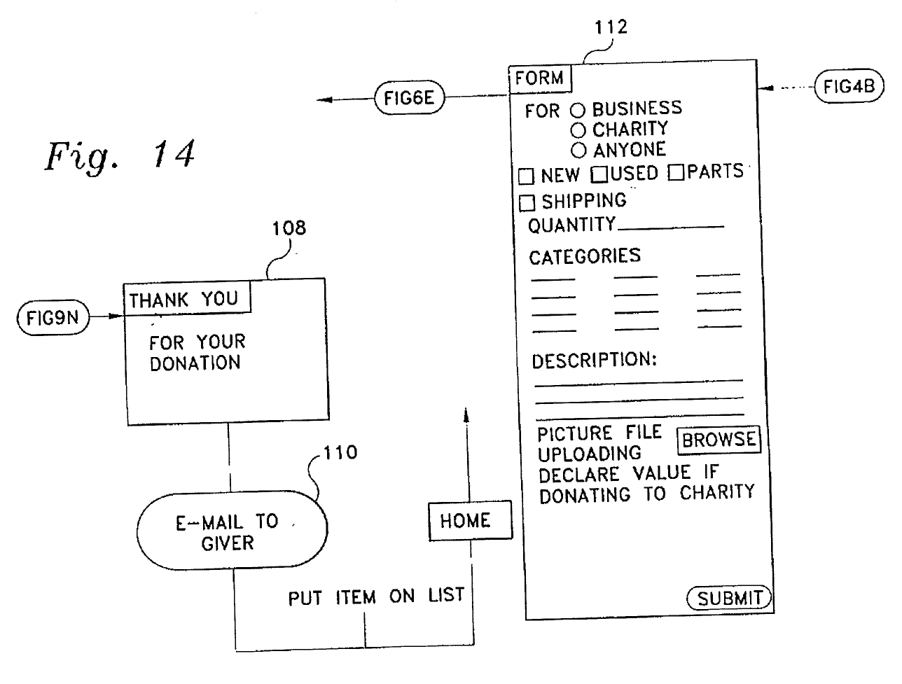

Turning now to FIG. 4, a “How to Throw” web page 34 is first described. This page is linked from the TO THROW icon on the Home Page 20 from FIG. 2 and is open to all users of the web site, (i.e., both registered users and the public). First time users are presented with Terms and Conditions that must be accepted, by selecting the “proceed” button, before any item can be donated. Once the proceed button is selected and any non-first-time users are passed directly to a web page donation form 112, described in association with FIG. 14.

Turning now to FIG. 14, donation form 112 enables a user to designate which class(es) of users is allowed to retrieve or get the item when initially posted, indicate what condition the item is in, indicate how many or how much of the item is available, identify the category or categories into which the item falls, provide an additional written description of the item, upload a photo of the item (if applicable), and indicate the fair market value of the item (if any). Following submission, the user is transferred to the registration/log-in web page illustrated in FIG. 6 (if the user had not already signed in) or sent to “thank you” web page 108 (if the user had already signed in; link not shown). In conjunction with being sent to web page 108, the user receives an email confirmation 110 of the donation (potentially for tax receipt purposes) before being returned to Home Page 20 (in FIG. 2).

Turning back to FIG. 4, two additional web pages 30,32 are illustrated, both of which are linked directly from Home Page 20 in FIG. 2. The “Everyone” Categories Page 30 lists all categories of items available to all users of the web site. Once a particular category is selected by the user (on web page 30 or directly in the EVERYONE(CATEGORIES) section of Home Page 20), the user is presented with a specific list of items available in that category on web page 32. If a more narrow listing of such items is desired by the user, the list can be further subcategorized by selecting one of the buttons (New, Used, or Broken) illustrated on web page 32. By double clicking on a particular item or by single clicking an item and then activating the Take button, the user is able to request receipt of the item. If the user has not signed in, he is then required to do so (and is transferred to log-in/registration page 46 shown in FIG. 6). If already signed in, the user is transferred directly to web page form 102 described in FIG. 13 hereinafter.

Jumping ahead briefly to FIG. 13, if an item is requested to be “taken” from the list on web page 32, the user is eventually linked to web page form 102. The user/recipient member then fills out the form 102, which preferably includes identification of the item being taken, shipping information, and contact information. If the recipient member is classified as a charity, then it is preferable that the recipient member provide the donor member with an appropriate receipt to facilitate the donor member's ability to obtain a tax deduction for the item. The form also determines how the shipping is to be paid for. As discussed previously, this payment might be borne in part or in whole, by the recipient member, donor member, or a third-party (e.g., philanthropic donor, or web site operator). If a third-party has pledged to bear such costs (possibly as a result of solicitations for such posted on the web site), then such pledge preferably is identified to the recipient member. It also preferably is identified with the identification of the particular item. Following completion of Take Form 102, an email 104 is preferably sent to the donor member (giver) and another email 106 is preferably sent to the recipient member (taker). The latter email preferably includes a reminder that a receipt, when appropriate, should be provided to the giver. Following this, the user is returned to the Home Page 20.

Turning now to FIG. 5, one embodiment of the present invention enables the user to select a “localized” version of the Home Page 20. As shown in block 38, the number of cities, counties, states, or regions for which localized service is available is determinable by the operator of the system (herein also referred to as a “facilitator”). Assuming a plurality of localized Home Pages 20 are available, the user is allowed to search for the closest such localized version of the Home Page 20 via search web page 36. Selection is preferably performed via a map on which the user selects or clicks on their region or by means of a pull-down menu of available choices. Once a particular city, county, state, or region is selected, the localized Home Page 40 is presented to the user. Home Page 40 is generally the same as Home Page 20, however, most items listed and posted for donation will be limited by the locality. The functionality of the web site as a whole remains unaffected otherwise.

Turning now to FIG. 6, two conventional web pages are first described. The first web page 42 is an advertisement opportunities listing web page in which potential advertisers on the web site are able to obtain information about placing advertisements therein. The second web page 44 is a Help web page that explains “how to throw” (or donate) items and “how to take” (or retrieve) items from the web site. Both of these web pages are linked from the general Navigation section of the Home Page 20.

Still referring to FIG. 6, the registration/sign-in/log-in web page 46 is illustrated. New users are required to register using a web page registration form 48. User name and password can be confirmed via web page 66 and email 68 or changed via web page 70 (all of which are illustrated on the top of FIG. 9). Existing users merely are required to sign-in or log-in in conventional manner on web page 46. The registration/sign-in/log-in web page 46 is linked from many different web pages within the web site. As shown in FIG. 9, once signed or logged in via web page 66, the user is redirected by the web server to the appropriate web page to which he was intending to go (shown by the empty circle, which signifies the appropriate routing functionality of the web server) when he was originally sent to the sign-in web page 46 (from FIG. 6).

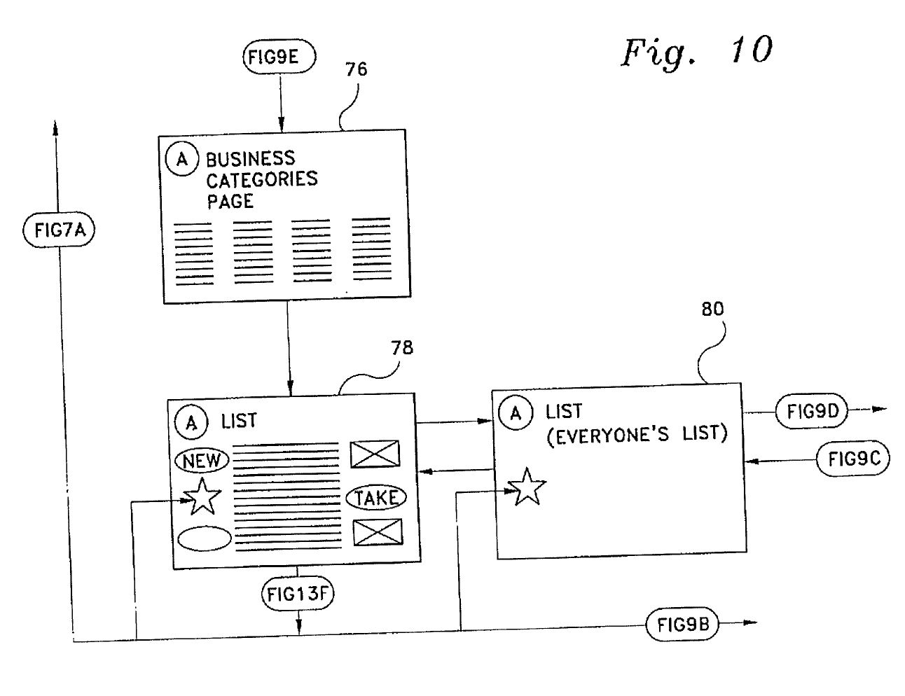

Turning now to FIG. 7, additional conventional web pages are illustrated. Specifically, these web pages include an “About Us” web page 50 and a “Press Releases” main web page 52, with linked web pages 58 dedicated to each specific press release. FIG. 7 also includes a “provide comments” web page 56, which enables a user to input comments regarding any particular giver or donor of items to the web site. This web page 56 is linked from FIGS. 3 and 10 as shown. Web page 54 provides a list of available shippers and shipping means, such as Federal Express (FedEx), United Parcel Service (UPS), the United States Postal Service (USPS), and the like. This information is linked to the general Navigation section of Home Page 20 and is capable of being linked from donation form 102 (in FIG. 13) if necessary or desired.

Referring now to FIG. 8, items highlighted in the FEATURED ITEMS, URGENT REQUESTS section of the Home Page 20 (of FIG. 2) are listed in greater detail on web page 60. By selecting a particular item, the user is able to read an article presented on web page 62, which provides even greater detail about the disaster and specific need or item desired. If the user wants to provide specific help, she can select the “submit button,” which allows her to throw an item or sign-in and then throw an item.

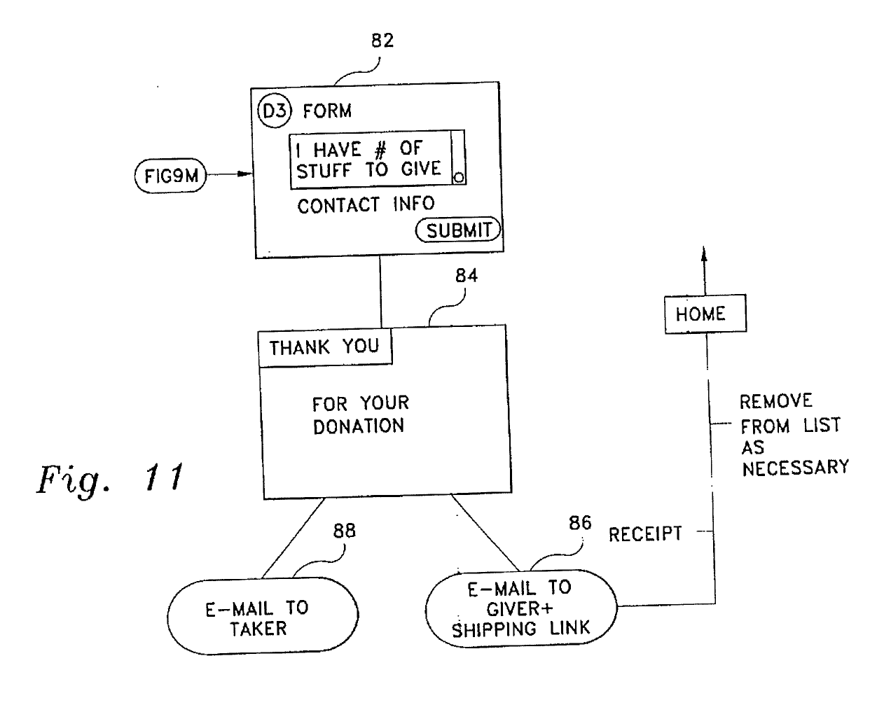

Preferably, throwing an item that is subject to an urgent request is handled using form 82, as illustrated in FIG. 11. This form 82 is a stream-lined version of the form 102 shown in FIG. 13. Form 82 enables the user to specify the amount or number of items available for donation and provides the user's contact information. Once the form 82 is submitted, the user is directed to a “thank you” web page, which can be printed off for tax receipt purposes. In addition, an email 88 is sent to the recipient (taker) of the item and an email 86 containing shipping instructions is sent to the donor (giver). If this donation satisfies the urgent request, such request is removed from the list on web pages 60, 62 (in FIG. 8) and in the appropriate area on Home Page 20 (in FIG. 2).

If the user desires to “post” an urgent need for an item, she is directed to web page form 64, in which she is able to list specific items needed and by whom. Item submitted (and preferably approved by the operator of the web site) are the posted on web page 60. One skilled in the art will appreciate that various forms of monitoring the addition of new items is preferably employed to maintain the quality of the list. This could be a manual system of scanning the item prior to allowing it to be entered, or restricting entry of items to certain pre-qualified users. In the latter case, one skilled in the art will appreciate that the user identity must be established during this step.

Referring again to FIG. 9 and as stated previously, once signed or logged in via web page 66, the user is redirected by the web server to the appropriate web page to which he was intending to go (shown by the empty circle, which signifies the appropriate routing functionality of the web server) when he was originally sent to the sign-in web page 46 (from FIG. 6). The routing function of the web server is able to direct the user to many different web pages described in detail in association with FIGS. 10-14, as shown. In addition, the routing function also directs users who qualify as donor members of the charitable organization classification (“charitable user”) to web page 72, which lists categories of items available only to charitable users. Similar to the “Everyone” Categories web page 30 (from FIG. 4), once a particular category is selected by the charitable user, the charitable user is presented with a specific list of items available in that category on web page 74. It should be noted that items available to all users (shown on and linked from web page 80 in FIG. 10) are also preferably included within the list shown on web page 74. If a more narrow listing of such items is desired by the user, the list can be further subcategorized by selecting one of the buttons (New, Used, or Broken) not all of which are illustrated on web page 74. By double clicking on a particular item or by single clicking and item and then activating the Take button, the charitable user is able to request receipt of the item. The user is transferred directly to web page form 102 described in FIG. 13 previously. The “star” logo enables the user to input comments about a particular giver or donor of an item, as shown by web page 56 in FIG. 7, described previously.

Turning now to FIG. 10, a user who qualifies as a “business” (“business user”) is routed by the web server (from FIG. 9) to web page 76, which lists categories of items available only to business users. Similar to the “Everyone” Categories web page 30 (from FIG. 4), once a particular category is selected by the business user, the business user is presented with a specific list of items available in that category on web page 78. It should be noted that items available to all users (shown on and linked from web page 80) are also preferably included within the list shown on web page 78. If a more narrow listing of such items is desired by the user, the list can be further subcategorized by selecting one of the buttons (New, Used, or Broken) not all of which are illustrated on web page 78. By double clicking on a particular item or by single clicking and item and then activating the Take button, the business user is able to request receipt of the item. The user is transferred directly to web page form 102 described in FIG. 13 previously. Once again, the “star” logo enables the user to input comments about a particular giver or donor of an item, as shown by web page 56 in FIG. 7, described previously.

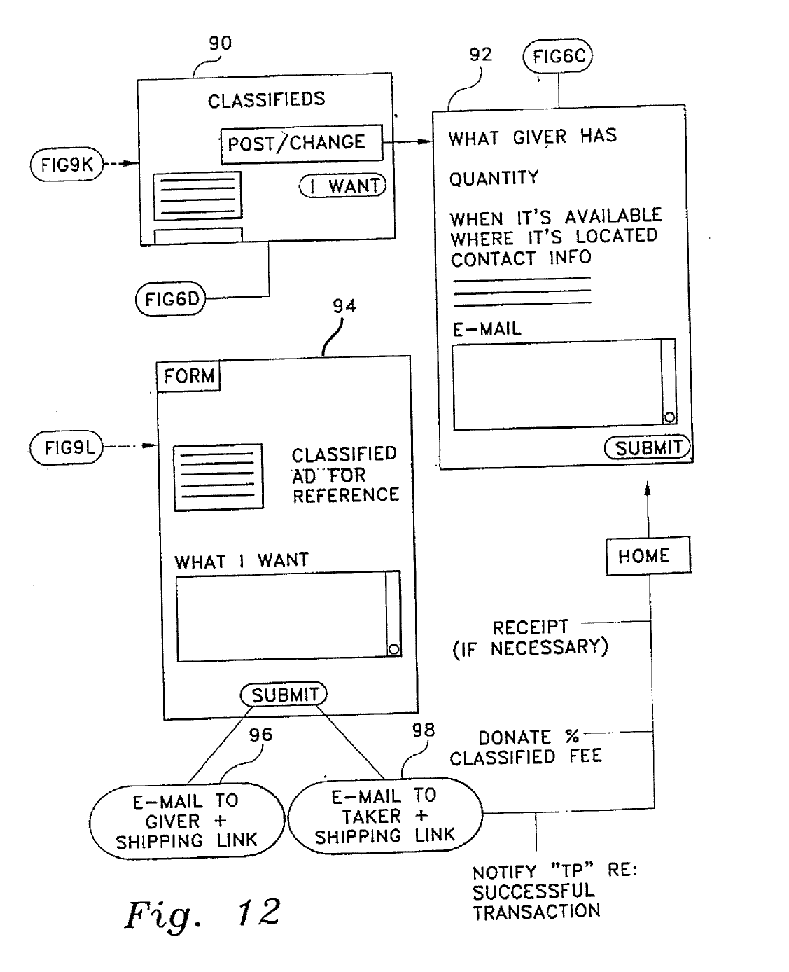

Turning now to FIG. 12, web page 90 provides an alternative means by which a user is able to throw or donate an item or request an item using a classified-type advertisement on the web site. The user selects “post/change” to list an item for donation or “I want” to request an item. In either case, the user is direct to web page form 92, into which the user inputs what item is being donated or requested, how much or how many are desired, when it is or needs to be available, where it is or needs to be located, contact information of the user, and any additional information submitted within the email field. Once submitted, the user is returned to the Home Page 20.

Still referring to FIG. 12, once a recipient member selects a classified ad containing an item of interest (from a list or web page not shown), the user is presented with web page form 94, by which the recipient member is able to indicate the item(s) desired and submit the request to the donor. The request is sent by email 96 to the donor (giver) along with shipping information and another email confirmation 98 is sent to the recipient. The web server then performs several functions, including notifying the operator of the system of the successful transaction, extracts or bills for any specified user fees associated with the classified advertisement, provides a receipt (if necessary) or notifies the charitable organization to provide a receipt (if applicable). The user is then returned to the Home Page 20.

Turning again to FIG. 13, the “PA” section of the Home Page 20 (from FIG. 2) provides a link to the Philanthropic Assistance (PA) web page 100. As shown, this web page 100 enables a philanthropic donor user to donate or offer money or services (as opposed to an item) to the system for the specific purpose of facilitating transactions between other donor and recipient members on the web site. Such donations or offers can be open for any particular use or restricted to particular items, charities, areas of the country, particular services, particular causes, and the like.

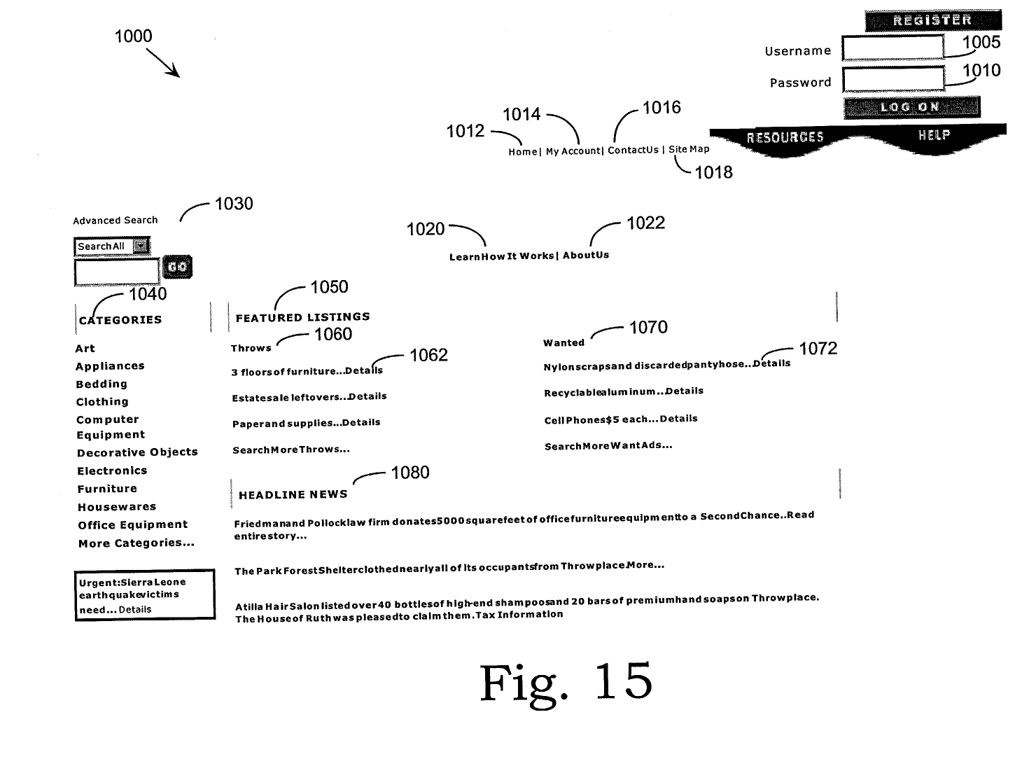

Turning now to FIGS. 15-18, a user interface over the Internet for a second preferred embodiment of the present invention is illustrated.

As shown in FIG. 15, Home Screen 1000 provides a general web interface for the present invention. In this present embodiment the user may enter her user-name into User Name Box 1005, along with her password into Password Box 1010. As discussed previously, the user may be an individual, a representative of a charity, or a representative of a business, among other things.

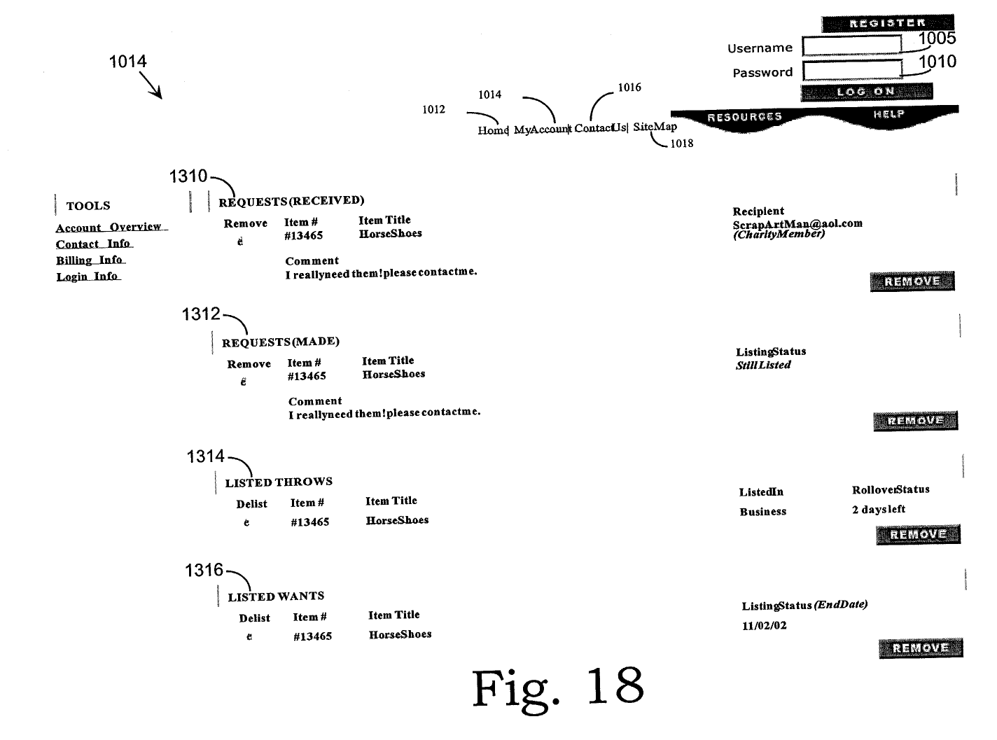

Links are provided to assist the user in navigation of the web site interface to utilize the present invention. Home Link 1012 provides a link to the present Home Page 1000. The link for My Account 1014 provides a link to a screen for My Account 1014 as shown in FIG. 18, which is discussed hereinafter.

Contact Us 1016 preferably provides means for the user to contact the administrators of the site. One skilled in the art will appreciate that these means can include telephonic, mail address, facsimile, email, web postings, and the like. About Us 1020 preferably provides information about the site and instructions on how to utilize the site.

Although not shown in FIG. 15, Home Site 1012 preferably has three main buttons (THROW, GET, and WANT) which, when selected by the user, transfers the user to the respective and relevant web page(s) upon which the user is able to throw (or donate) an items, look for an item thrown by someone else, or post an item that they are looking to find. These web pages function in a similar manner to the comparable web pages for the embodiment described in association with FIGS. 2-14.

In addition to the three links to THROW, GET, and WANT, Home Site 1012 preferably has a “main features” area, which presents information and links to, among other things, Categories 1040, Featured Listings 1050, and Headline News 1080.

Categories 1040 is utilized to provide links to different kinds or categories of items which are transferred in the present invention. One skilled in the art will appreciate that links of the categories are links to predefined web pages in which items are placed according to their type. Alternatively these links are used to generate searches based on the category selected. The types of categories shown (although not comprehensive) include: Art, Appliances, Bedding, Clothing, Computer Equipment, Decorative Objects, Electronics, Furniture, Housewares, Office Equipment, and the like. It is preferable to provide an additional link to “More Categories” to facilitate a display of additional categories which might not conveniently “fit” in Home Site 1000, or which are used less frequently.

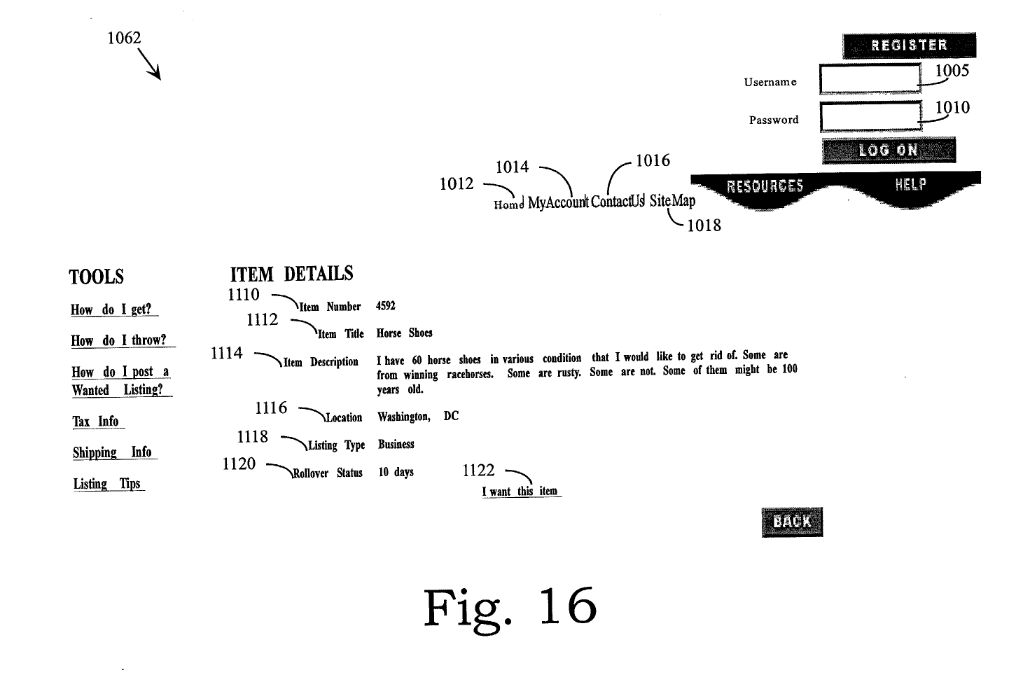

Featured Listings 1050 preferably contains two sub-listings of Throws 1060 (items available for pick up) and Wanted 1070 (items that users are looking for) Throws link 1060 contains the items which are available for donation. It is preferable to provide a link to Throw Details 1062 for each item. FIG. 16 depicts a web page of information available by linking through the Throw Details link 1062. It is preferable to provide item details including Item Number 1110, Item Title 1112, Item Description 1114, Location 1116, Listing Type 1118, and Rollover Status 1120.

Item Number 1110 is preferably a unique identifier of the item, for example a numeric identifier. Item Title 1112 provides an alphanumeric title or short description of the item for which a user might be able to quickly gain an understanding of what the item entails. In the present embodiment this title is “Horse Shoes.” Item Description 1114 is a more detailed description of the item. In the present example this is; “I have 60 horse shoes in various condition that I would like to get rid of. Some are from winning race horses. Some are rusty. Some are not. Some of them might be 100 years old.” Location 1116 provides the geographical location of where the item currently is. In the present embodiment this is “Washington D.C.” Listing Type 1118 provides the type of listing that the item is. In the present example this is “Business.” Other types may include “charity” or “public.” Rollover Status 1120 provides the time left until rollover of the item. As discussed above, in some embodiments it may be preferable to have the item be made available to additional groups if a certain amount of time passes without the item being taken. For example, a item identified for “charity” only may roll over to “business” (or “business” and “charity”) after a predetermined period of time and then roll-over to “public” after another predetermined period of time.

It is also preferable to allow the item to be selected to be taken from Item Detail 1062. A Select Item link 1122 is preferably provided. When a user selects the Select Item link 1122 the interface preferably facilities transfer of the item. One skilled in the art will appreciate that upon selecting the item contact information can then be provided so that the receiver can contact the donor. Other embodiments include the ability for providing automated shipping, or choices of the ability to choose means of shipping the item. Other features include providing the ability for the recipient to pay for part of or all of the shipping and handling costs associated with the transfer of the item.

Turning back to FIG. 15, a second portion of Featured Listings 1050 is the list of the sought for items under Wanted 1070.

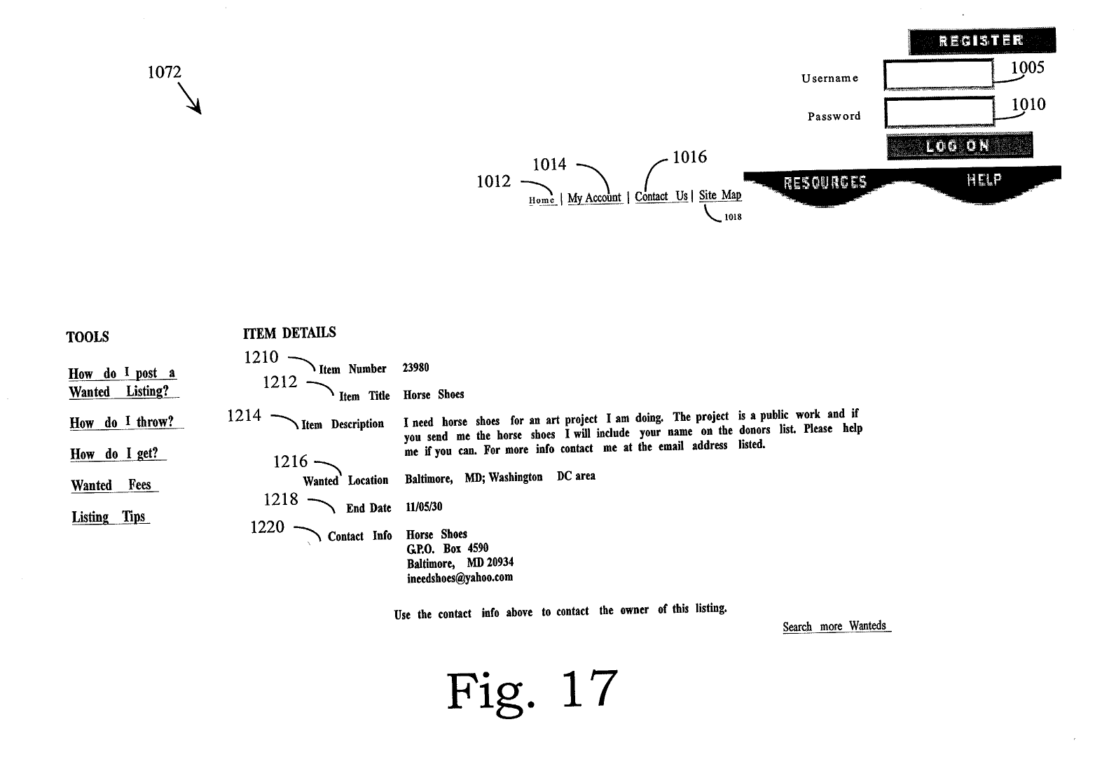

It is preferable to provide a link to Wanted Details 1072 for each item. FIG. 17 depicts an embodiment of Wanted Details 1072. It is preferable to provide item details including Wanted Item Number 1210, Wanted Item Title 1212, Wanted Item Description 1214, Wanted Location 1216, End Date 1218, Contact Info 1220.

Wanted Item Number 1210 is preferably a unique identifier of the item, for example a numeric identifier. This would be the same identifier as Item Number 1110. Wanted Item Title 1212, as with Item Title 1112, provides an alphanumeric title or short description of the item for which a user might be able to quickly gain an understanding of what the item entails. In the present embodiment this title is “Horse Shoes.” Wanted Item Description 1214 is like Item Description 1114 and is a more detailed description of the item. In the present example this is; “I need horse shoes for an art project I am doing. The project is a public work and if you send me the horse shoes I will include your name on the donors list. Please help me if you can. For more info contact me at the email address listed.” Wanted Location 1216 provides the geographical location of where the item would be sent. In the present embodiment this is “Baltimore, Md.; Washington D.C. area.”

End Date 1218 provides the date of when the item is no longer needed. Other embodiments may have a maximum time the request could remain. This keeps requests from becoming “stale” or no longer needed. Contact Information 1220 provides the ability for a donor to contact the requestor. In the present embodiment that is:

Horse Shoes

G.P.O. Box 4590

Baltimore, Md. 20934

ineedshoes@yahoo.com

Turning back to FIG. 15, the user is also able to see Headline News 1080 postings. This provides an area containing news that the users might find informative.

Finally, turning to FIG. 18, a user is presented with My Account 1014 information, which preferably includes Requests (Received) 1310, Requests (Made) 1312, Listed Throws 1314, and Listed Wants 1316. All the above four preferably display Item Number and Item Title, which was discussed previously, and enable the user to Remove or Delist the item.

Requests (Received) 1310 preferably includes the Recipient of the item when available. This may be the recipient's email address, mailing address, user-name or other identifiable information.

Requests (Made) 1312 include the listing status of the item. This includes the following statuses: “Still Listed”, “Expired”, “Donor found” and the like.

Listed Throws 1314 identifies the classification of recipient members which are allowed to receive the item thrown, such as “Business” or “Charity” or “Public.” Listed Throws 1314 also includes Roll Over Status, which was discussed previously.

Listed Wants 1316 includes Listing Status, which typically identifies the Ending date of the request for the listed item among other things.

In view of the foregoing detailed description of preferred embodiments of the present invention, it readily will be understood by those persons skilled in the art that the present invention is susceptible of broad utility and application. While various aspects have been described in the context of arborist uses, the aspects may be useful in other contexts as well. Many embodiments and adaptations of the present invention other than those herein described, as well as many variations, modifications, and equivalent arrangements, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof

What is claimed is:

1. In a system in which donor members transfer items to recipient members without receiving economic remuneration from the recipient members, a method for facilitating a transfer of an item from a donor member to a recipient member comprising the steps of:
(a) receiving information from each recipient member sufficient to classify each recipient member within predefined classes;
(b) receiving from a donor member information for a particular item to be donated, including a designation of at least one of the predefined classes as an eligible class of recipient members for receiving the particular item; and
(c) identifying the particular item to recipient members of the at least one eligible class.

2. The method of claim 1, further comprising not identifying the particular item to recipient members of the undesignated classes.

3. The method of claim 1, further comprising identifying the particular item to recipient members of the undesignated classes after a predetermined period of time in which the particular item remains available for retrieval by a recipient member of the at least one eligible class.

4. The method of claim 1, wherein a predefined class of recipient members comprises charitable organizations.

5. The method of claim 1, wherein a predefined class of recipient members comprises businesses.

6. The method of claim 1, wherein a predefined class of recipient members comprises individuals.

7. The method of claim 1, wherein a predefined class of recipient members comprises schools.

8. The method of claim 1, wherein the predefined classes of recipient members are mutually exclusive.

9. The method of claim 1, wherein the predefined classes of recipient members are not mutually exclusive.

10. The method of claim 1, wherein the items to be transferred are categorized.

11. The system of claim 1, wherein each of the donor members and recipient members must registered with a facilitator in order to participate in the system.

12. The system of claim 1, wherein the items include at least one of clothes, equipment, electronics, toys, cars, linens, appliances, crutches, eyeglasses, household items, construction materials, furniture, cell phones, fax machines, surplus goods, redistribution items, reallocation items, refurbished items, and recyclable items.

13. The method of claim 1, wherein the information is received from each recipient member during registration of the recipient member with a facilitator, the facilitator performing the claimed method.

14. The method of claim 13, wherein the facilitator includes a website on the Internet.

15. The method of claim 1, further comprising soliciting for a donation applicable to the transfer of the particular item to a recipient member.

16. The method of claim 15, wherein the solicited donation includes money to cover at least one of shipping cost, cleaning cost, and packaging cost.

17. The method of claim 1, further comprising the steps of,
(a) receiving from a second donor member a pledge applicable to the transfer of the particular item; and
(b) also identifying such pledge to recipient members of the at least one eligible class.

18. In a system in which donor members transfer items to recipient members without receiving economic remuneration from the recipient members, an Internet method for facilitating a transfer of an item from a donor member to a recipient member comprising the steps of:
(a) receiving information from each recipient member sufficient to classify each recipient member within predefined classes;
(b) receiving from a first donor member information for a particular item to be donated, including a designation of at least one of the predefined classes as an eligible class of recipient members for receiving the particular item;
(c) receiving from a second donor member a pledge applicable to the transfer of the particular item; and
(d) identifying through a website the particular item and the pledge to recipient members of the at least one eligible class.

19. The method of claim 18, wherein the pledge includes money to cover at least one of shipping cost, cleaning cost, and packaging cost associated with the transfer of the particular item.

20. A computer-readable medium having computer-executable instructions for facilitating a transfer of an item from a donor member to a recipient member in a system in which donor members transfer items to recipient members without receiving economic remuneration from the recipient members, the computer-executable instructions performing the steps of:
(a) receiving information from each recipient member sufficient to classify each recipient member within predefined classes;
(b) receiving from a donor member information for a particular item to be donated, including a designation of at least one of the predefined classes as an eligible class of recipient members for receiving the particular item; and
(c) identifying the particular item to recipient members of the at least one eligible class.
